(19) United States
(12) Patent Application Publication
(10) Pub. No.: US 2026/0316045 A1
(43) Pub. Date: Oct. 15, 2026

(54) SYSTEM FOR RECOVERING VOLATILE PT AND/OR RH AND METHOD THEREOF

(71) Applicant: Yara International ASA, Oslo (NO)

(72) Inventor: David WALLER, Porsgrunn (NO)

(21) Appl. No.: 19/485,337

(22) PCT Filed: Jul. 5, 2024
(86) PCT No.: PCT/EP2024/068982

§ 371 Date: Nov. 18, 2025

(30) Foreign Application Priority Data
Jul. 6, 2023 (EP) 23183867.3
Nov. 20, 2023 (EP) 23210965.2

(51) Int. Cl. B01J 20/06; B01J 8/02; B01J 23/42; B01J 23/46; C01B 21/26; C01B 21/28; C01C 3/02

(52) U.S. Cl. CPC B01J 20/06; B01J 8/0278; B01J 23/42; B01J 23/464; C01B 21/265; C01B 21/28; C01C 3/0216; C01C 3/0225; B01J 2208/00769

(57) ABSTRACT

A catalytic system comprising a Pt-containing and/or Rh-containing catalyst, and a recovery system downstream of the catalyst, wherein the recovery system comprises one or more oxide of a rare earth metal selected from the group consisting of Er₂O₃, Sm₂O₃ and Yb₂O₃. Also, the use of one or more oxides of a rare earth metal selected from the group consisting of Er₂O₃, Sm₂O₃, and Yb₂O₃ for recovering volatile Pt and/or Rh, and a method for recovering volatile Pt and/or Rh.

### TECHNICAL FIELD

The present application is in the field of the recovery of volatile precious metals, particularly volatile Pt and/or Rh from a gas phase.

### BACKGROUND

Several reactions require a catalyst to proceed at an acceptable rate and to produce the desired products. Such catalysts are often based upon precious, heavy metals, such as the so-called platinum group metals. The six platinum-group metals are ruthenium (Ru), rhodium (Rh), palladium (Pd), osmium (Os), iridium (Ir), and platinum (Pt).

For example, platinum (Pt) and/or rhodium (Rh) are commonly used as catalysts among others in the Ostwald process for nitric acid production, for oxidising ammonia into nitric oxide, and in the Andrussow process for hydrogen cyanide production, for reacting ammonia with oxygen and methane.

A problem associated with catalysis using platinum group metals, particularly Pt and/or Rh is that, due the high temperature at which catalysis is performed, for example from 700 to 950° C. or over 1000° C. or over 1100° C., some of these metals, such as Rh and/or Pt metal evaporate, in particular when the catalysis is performed in the presence of oxygen.

The recovery of volatile Pt with, in particular, palladium (Pd)-containing recovery systems is well documented.

For example, GB1343637 relates to a process and a related device for recovering platinum metals entrained in a hot gas stream (as in the manufacture of nitric acid) wherein the gas is passed through a gettering device in the form of an inert ceramic honeycomb structure which is coated with a getter containing Pd to absorb the volatile platinum.

EP63450 generally discloses a getter device and a related process for recovery of a precious metal lost from a precious metal-containing catalyst operating at elevated temperature, wherein the getter comprises an agglomeration or assemblage of unwoven fibres made from a metal selected from the group ruthenium, palladium, iridium, platinum, gold, silver, rhodium and alloys containing one or more or the said metals. The document primarily focuses on Pd/Au alloys.

GB668935 relates to a process and related device for platinum recovery of volatilized platinum, originating from a catalyst. In this context, GB668935 claims a process for recovery of platinum, wherein the platinum is trapped on the surface of baffles, disposed at a place where the temperature is at least 700° C. and wherein some of the baffles have a coating of silver or of a silver alloy with gold, palladium or platinum.

US20130149207 relates to an exhaust system arrangement comprising a Pt+Pd catalyst and a downstream SCR catalyst and a component capable of trapping and/or alloying with a gas phase platinum group metal, wherein this component is typically a metal selected from the group consisting of gold, palladium and silver, preferably a Pd/Au alloy.

On the side of Rh capture, U.S. Pat. No. 4,774,069A discloses a process for the manufacture of nitric oxide by oxidising ammonia in the presence of a catalyst comprising platinum and from 0 to 20 wt % of rhodium and from 0 to 40 wt % of palladium (based on the weight of alloy), the catalyst being located upstream from a catchment trap for scavenging platinum or rhodium lost from the catalyst. The catchment trap comprises an alloy of Pd with at least one compound selected from the group consisting of the oxides, borides, carbides, silicides, nitrides and silicates of aluminum, zirconium, boron, silicon, magnesium, titanium, yttrium, beryllium, thorium, manganese, lanthanum, scandium, calcium, uranium, chromium, niobium and hafnium.

The rhodium capture is significantly less documented than platinum capture, which indicates that it is more challenging to achieve. Nonetheless, at the moment the most expensive precious metal is Rh. Thus, it is of great interest to recover as much volatile Rh as possible.

There is thus a need in the art for compounds and materials for recovering volatile Pt and/or Rh and that are stable under ambient air.

### SUMMARY

The present application addresses one or more of the above indicated needs. The inventors have surprisingly found that certain oxides of rare earth metals as further defined herein are stable and effective recovery agents for recovering or trapping at least volatile Rh or at least volatile Pt and/or Rh. However, as will be shown in the examples, Yara has established that not all rare earth metal oxides are suitable for recovering volatile Pt and/or Rh.

In one aspect of the disclosure, a catalytic system is disclosed. The system comprises: a Pt-containing and/or Rh-containing catalyst; and a recovery system downstream of the catalyst.

The system is characterised in that the recovery system comprises one or more oxide of a rare earth metal selected from the group consisting of Er₂O₃, Sm₂O₃ and Yb₂O₃.

In particular embodiments, the system is characterised in that the recovery system comprises an oxide of a rare earth metal selected from Er₂O₃ and Sm₂O₃.

In one embodiment according to the system of the disclosure, the catalytic system is a catalytic system for the catalytic conversion of ammonia into nitric oxide, for the generation of nitric acid, such as present in an ammonia oxidation burner, or the catalytic system is a catalytic system for the catalytic conversion of ammonia, oxygen and methane into hydrogen cyanide, such as present in a reactor for reacting ammonia, oxygen and methane, thereby generating hydrogen cyanide.

In one embodiment according to the system of the disclosure, the recovery system comprises Sm₂O₃. In one embodiment according to the system of the disclosure, the recovery system comprises Sm₂O₃ and the catalyst system comprises a Rh-containing catalyst.

In one embodiment according to the system of the disclosure, the Pt-containing and/or Rh-containing catalyst is in the form of a catalytic gauze, and the recovery system has the shape of a honeycomb, a tablet, a pellet, a sponge, a net or a gauze.

In one aspect of the disclosure, the use of one or more oxides of a rare earth metal selected from the group consisting of Er₂O₃, Sm₂O₃ and Yb₂O₃, for recovering volatile Pt and/or Rh, or for recovering volatile Rh or volatile Rh and/or Pt, is disclosed.

In one embodiment according to the use of the disclosure, volatile Pt and/or Rh is generated during the catalytic oxidation of ammonia into nitric oxide, or volatile Pt and/or Rh is generated during the catalytic reaction of ammonia with oxygen and methane, thereby generating hydrogen cyanide.

In one embodiment according to the use of the disclosure, the oxide of the rare earth metal is Sm₂O₃ and/or Er₂O₃, in particular is Sm₂O₃.

In one embodiment according to the use of the disclosure, volatile Rh is recovered.

In one embodiment according to the use of the disclosure, the oxide of the rare earth metal is Sm₂O₃ and volatile Rh is recovered. In one embodiment according to the use of the disclosure, the oxide of a rare earth metal is comprised in a recovery system that has the shape of a honeycomb, a tablet, a pellet, a sponge, a net or a gauze.

In one aspect of the disclosure, a method for oxidising ammonia into nitric oxide or for reacting ammonia with oxygen and methane, thereby generating hydrogen cyanide, is disclosed. The method comprises the steps of:
a) catalytically oxidising ammonia into nitric oxide or catalytically reacting ammonia with oxygen and methane thereby generating hydrogen cyanide, whereby volatile Pt and/or Rh is generated;
b) contacting the volatile Pt and/or Rh generated in step a) with a recovery system comprising one or more oxide of a rare earth metal selected from the group consisting of Er₂O₃, Sm₂O₃ and Yb₂O₃ to form a compound or a solid solution with Pt and/or Rh; and
c) recovering Pt and/or Rh from the compound or the solid solution generated in step b) In one embodiment according to the method of the disclosure, step a) is performed with a catalytic gauze, and step b) is performed with a recovery system that has the shape of a honeycomb, a tablet, a pellet, a sponge, a net or a gauze.

In one embodiment according to the method of the disclosure, step b) is performed with a recovery system comprising Sm₂O₃ and/or Er₂O₃, in particular comprising Sm₂O₃.

In one embodiment according to the method of the disclosure, step a) is performed with a Rh-containing catalytic system and step b) is performed with a recovery system comprising Sm₂O₃.

In one embodiment according to the method of the disclosure, step a) comprises catalytically oxidising ammonia into nitric oxide at a temperature ranging from 700 to 950° C.

In one aspect of the disclosure, a method for revamping a palladium-containing recovery gauze for recovering volatile platinum and/or rhodium is disclosed. The method comprises the step of replacing at least part of the palladium comprised in the recovery gauze for one or more oxide of a rare earth metal selected from the group consisting of Er₂O₃, Sm₂O₃ and Yb₂O₃.

### DESCRIPTION OF THE FIGURES

FIG. 1 shows the XRD analysis of the pellet before exposure to the reactor (“fresh”) and the upper surface of the reactor exposed (“pilot tested” or “pilot”) Sm₂O₃ pellet. The fresh surface is indicated by the solid line, the pilot tested surface is indicated by the dashed line.

FIG. 2 shows the XRD patterns of the pellet before exposure and the upper surface of the reactor exposed Er₂O₃ pellet. The pattern for the pellet before exposure is indicated by the solid line, the pattern for the exposed surface is indicated by the dashed line.

FIG. 3 shows the XRD patterns of the pellet before exposure and the upper side of a reactor exposed Yb₂O₃ pellet. The pattern for the pellet before exposure is indicated by the solid line, the pattern for the exposed surface is indicated by the dashed line.

### DETAILED DESCRIPTION

Throughout the description and claims of this specification, the words “comprise” and variations thereof mean “including but not limited to”, and they are not intended to (and do not) exclude other moieties, additives, components, integers or steps. Throughout the description and claims of this disclosure, the singular encompasses the plural unless the context otherwise requires. In particular, where the indefinite article is used, the disclosure is to be understood as contemplating plurality as well as singularity, unless the context requires otherwise.

Features, integers, characteristics, compounds, chemical moieties, or groups described in conjunction with a particular aspect, embodiment or example of the disclosure are to be understood to be applicable to any other aspect, embodiment or example described herein unless incompatible therewith. All of the features disclosed in this disclosure (including the description, claims, abstract and drawing), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this disclosure (including the description, claims, abstract and drawing), or to any novel one, or any novel combination, of the steps of any method or process so disclosed. The enumeration of numeric values by means of ranges of figures comprises all values and fractions in these ranges, as well as the cited end points. The terms “ranging from . . . to . . . ” or “range from . . . to . . . ” or “up to” as used when referring to a range for a measurable value, such as a parameter, an amount, a time period, and the like, is intended to include the limits associated to the range that is disclosed.

The present application generally provides methods and systems for the recovery of one or more volatile platinum group metals, present in a gas phase.

As used herein, the terms “recover”/“recovery” are used interchangeably with the terms “capture”, “capturing”, “catchment”, “retain”/“retaining”, or “trapping”. These terms are used in the meaning that the element that is recovered or captured by a recovery system according to the present application is incorporated into the rare earth metal oxide crystal lattice or forms a compound or solid solution with the rare earth metal oxide. A solid solution as used herein generally refers to a homogeneous mixture of two different kinds of atoms or components in solid state and having a single crystal structure. Stated differently, and in line with the IUPAC definition, a solid solution is a solid in which its components are compatible and form a unique phase, such as a single crystal structure. More in particular, in the crystal structure, one component, i.e. the element that is recovered, in particular Rh, or Rh and/or Pt, fits into and is distributed in the crystal lattice of a second component, in particular one or more oxides of a rare earth metal selected from the group consisting of Er₂O₃, Sm₂O₃, and Yb₂O₃.

The recovery or capture of a particular element by a recovery system according to the present application can be determined by scanning electron microscope (SEM) with energy dispersive X-ray fluorescence analysis (EDS) and/or by X-Ray diffraction (XRD) analysis, particularly by comparing the data obtained by these techniques before and after contacting the recovery system according to the present application with a gas comprising one or more volatile platinum group metals, in particular Pt and/or Rh. EDS analysis will demonstrate the presence or absence of the metal of interest to be recovered in the recovery system. XRD shows the effect of the incorporation of the metal of interest to be recovered in the recovery system, particularly in the crystal structure of the recovery agent, as further described herein, or as a formed compound or solid solution with the recovery agent.

In one aspect of the disclosure, a catalytic system is disclosed. In general, the catalytic system comprises a catalyst comprising one or more platinum-group metals, and a recovery system, positioned downstream of the catalyst, for recovering volatile platinum-group metals that are released from the catalyst during operation. In particular, the system according to the present disclosure comprises a catalyst comprising at least Pt and/or Rh and a recovery system downstream of the catalyst. The system is characterised in that the recovery system comprises one or more oxides of a rare earth metal selected from the group consisting of Er₂O₃, Sm₂O₃, and Yb₂O₃, particularly in crystalline form.

In another embodiment of the disclosure, the system is characterised in that the recovery system comprises oxide of a rare earth metal selected from Er₂O₃ and Sm₂O₃. In certain embodiments of the present disclosure, the system is characterized in that the recovery system comprises Sm₂O₃.

By a catalytic system, it is meant herein, a system comprising a catalyst, with which the chemical activation barrier for reacting two chemicals is lowered, such that the reaction can be performed using less energy. The catalyst as considered herein typically comprises at least Pt and/or Rh, but may contain other metals or metal containing compounds as well, including but not limited to other platinum group metals, such as Pd, Ir, Ru, Os; and/or other metals, such as Au, Ar, Cu, Fe, Ni, Co and the like; and/or compounds or alloys containing one or more of said metals. In the context of the present disclosure, during operation of the catalyst, at least Pt and/or Rh is liberated in the gas phase, in other words volatile Pt and/or Rh is generated. In certain embodiments, the catalyst system comprises Rh and volatile Rh is generated.

By recovery system, it is meant a system in which the volatile catalyst metal, in particular the volatile platinum group metal, more in particular volatile Pt and/or Rh, present in the gas phase and generated during a catalytic reaction in the catalytic system is recovered, as defined above. The recovery system according to the present disclosure particularly recovers at least Rh, or at least Pt and/or Rh through retaining or capturing at least Rh, or at least Pt and/or Rh with the rare earth metal oxide as further defined herein, in particular by incorporating Rh, or Pt and/or Rh into the crystal lattice of the rare earth metal oxide.

The inventor has surprisingly found that Er₂O₃, Sm₂O₃ and Yb₂O₃, retain volatile Pt and Rh, thereby allowing to recover the volatile Pt and Rh that would otherwise be lost in the gas phase. Thereby, both emissions in the air and loss of precious and expensive metals are mitigated. It was further observed that in contrast to the above-mentioned oxides, CeO₂ did not retain volatile Pt and Rh. Hence, Er₂O₃, Sm₂O₃ and Yb₂O₃ have the ability to form a compound or a solid solution with Rh and Pt. Advantageously, the formed compound or solid solution is stable: upon shut-down of the reactor and exposure to ambient temperature and ambient air, the compound or solid solution does not hydrate and do not become brittle and dusty.

In one embodiment according to the system of the disclosure, the catalytic system is an ammonia oxidation reactor or burner, whereby nitric oxide therefore is generated. In one embodiment, the catalytic system is a reactor for reacting ammonia, oxygen and methane, thereby generating hydrogen cyanide. Stated differently, in certain embodiments, the catalytic system is a system for the catalytic conversion of ammonia into nitric oxide, for the generation of nitric acid, or the catalytic system is a system for the catalytic conversion of ammonia, oxygen and methane, for the generation of hydrogen cyanide. The present invention thus considers an ammonia oxidation reactor or burner comprising a catalytic system according to the present disclosure, or a reactor for the manufacture of hydrogen cyanide by the catalytic reaction of ammonia, methane and oxygen, comprising a catalytic system according to the present disclosure.

The present disclosure addresses the recovery of at least volatile Pt and/or Rh from a gas phase. Two very well know industrial production processes are the production of nitric acid according to the Ostwald process and the production of hydrogen cyanide according to the Andrussow process. Both these processes involve the presence of a Pt and/or Rh containing catalyst. Indeed, in the production of nitric acid according to the Ostwald process, the first step involves the reaction of gaseous ammonia with gaseous oxygen provided for example through air onto a Pt/Rh catalyst, thereby producing gaseous nitric oxide. The catalyst comprising Pt and Rh usually is part of a so-called ammonia oxidation burner in which the Pt/Rh catalyst is located at the top surface of a so-called burner basket and supported by Raschig rings or catalyst particles for example for N₂O gas conversion and abatement located inside the burner basket. After contacting the Pt/Rh catalyst, the ammonia and oxygen react at suitable temperatures and pressures as known to the skilled person to form gaseous nitric oxide, which passes through the burner basket and is further subject to the subsequent steps of the nitric acid production process. EP3727667A1 and WO2004/005187A1 describe potential designs for the ammonia oxidation burner basket.

Regarding the production of hydrogen cyanide according to the Andrussow process, it also involves the reaction of gaseous ammonia, oxygen and methane that are fed to a reactor and subsequently reacted in the reactor onto a catalyst bed comprising Pt/Rh gauzes at suitable temperatures and pressures as known to the skilled person.

It results that the catalytic system of the disclosure is particularly helpful for performing the Ostwald and Andrussow processes generating nitric acid and hydrogen cyanide respectively, particularly for recovering at least volatile Pt and/or Rh generated during the Ostwald and Andrussow processes.

In one embodiment according to the system of the disclosure, the recovery system comprises Sm₂O₃. The inventor has found that the catchment of volatile Pt and Rh is even more increased when the rare earth oxide in the recovery system is Sm₂O₃. Said otherwise, there are benefits in terms of volatile Pt and Rh recovery associated with a recovery system comprising Sm₂O₃.

In one embodiment according to the system of the disclosure, the recovery system comprises Sm₂O₃ and the catalyst system comprises a Rh-containing catalyst.

The inventor has found that not only does the recovery of volatile Pt and/or Rh improve upon using Sm₂O₃ in the recovery system, the Rh recovery is also then improved, that is more selective, with respect to Pt catchment. Said otherwise, the combination of a Rh containing catalyst and Sm₂O₃ in the recovery system of the system of the disclosure results in improved Rh recovery.

In certain embodiments, the system of the present disclosure may further comprise a second recovery system, particularly for the capture of volatile catalyst metals, such as volatile platinum group metals. In a particular embodiment, the second recovery system comprises metals or compounds suitable for the capture of volatile catalyst metals, such as volatile platinum group metals, in the gas phase. Such metals or compounds include but are not limited to Pd, Au, Ag, and mixtures of alloys thereof. In certain embodiments, the second recovery system comprises Pd or Ag for the capture of volatile Pt. The second recovery system may be positioned between the catalyst and the recovery system according to the present disclosure and comprising Er₂O₃, Sm₂O₃, and/or Yb₂O₃, such as comprising Er₂O₃ and/or Sm₂O₃, and/or may be positioned downstream of the recovery system according to the present disclosure comprising Er₂O₃, Sm₂O₃, and/or Yb₂O₃, such as comprising Er₂O₃ and/or Sm₂O₃.

In certain embodiments, the recovery system comprising Er₂O₃, Sm₂O₃ and/or Yb₂O₃, such as comprising Er₂O₃ and/or Sm₂O₃, according to the present disclosure may further comprise other metals, compounds or alloys suitable for the capture of volatile catalyst metals, such as volatile platinum group metals. Such metals or compounds include but are not limited to Pd, Au, Ag, and mixtures of alloys thereof.

Advantageously, the presence of a second recovery system or the presence of further metals or compounds suitable for the capture of volatile platinum group metals allows to maximize the recovery of volatile catalyst metals from the gas phase or to obtain the recovery of volatile catalyst metals from the gas phase in the most cost-effective way, particularly to maximize the recovery of volatile platinum group metals from the gas phase.

In one embodiment according to the system of the disclosure, the Pt-containing and/or Rh-containing catalyst is in the form of a catalytic gauze, and the recovery system has the shape of a honeycomb, a tablet, a pellet, a sponge, a net or a gauze.

Honeycomb monoliths and nets offer a large geometric surface area and also very low pressure drop, which is of benefit for the gas to contact either the Pt and/or Rh catalytic metal or the rare earth oxide recovery metal.

Gauzes also offer the advantage of low pressure drop, in addition to high mass transfer which favours both the catalytic conversion onto the Pt and/or Rh metal and the interaction of the volatile Pt and/or Rh with the rare earth oxide, resulting in the retaining of the volatile Pt and/or Rh by the rare earth oxide.

The shape of pellets or tablets can be adjusted and optimised such as to offer a maximised geometric surface area. Further, pellets and tablets are easy to produce, and large volumes can be easily installed and subsequently used in large sized reactors such as circular ammonia oxidation burners.

Sponges, foams and ceramics also offer a large geometric surface area and also exhibit a very low pressure drop, which is of benefit for the gas to contact either the Pt and/or Rh catalytic metal or the rare earth oxide recovery metal. Moreover, sponges, foams and ceramics present the advantage of increased mass transfer with respect to other shapes. When the recovery system has the shape of a honeycomb, a tablet, a pellet or a net, the recovery system can be made by coating the rare earth oxide onto a support having the preferred shape. Coating of the rare earth oxide onto a support with a defined shape is particularly straightforward to perform and to achieve.

Alternatively, the shape can be produced from a composite of the rare earth oxide or from the solid pure rare earth oxide. Examples of production from a composite of the rare earth oxide or the pure rare earth oxide are extrusion, moulding, pressing or granulating the composite of the rare earth oxide or from the solid pure rare earth oxide.

In one aspect of the disclosure, the use of one or more oxides of a rare earth metal oxide selected from the group consisting of Er₂O₃, Sm₂O₃ and/or Yb₂O₃, such as Er₂O₃ and/or Sm₂O₃, particularly in crystalline form, for recovering one or more volatile platinum group metals, in particular for recovering at least volatile Pt and/or Rh from a gas phase, or for recovering at least volatile Rh, and optionally volatile Pt, is disclosed.

The inventor has surprisingly found that, contrary to cerium oxide, CeO₂ and as shown in the examples, Er₂O₃, Sm₂O₃ and Yb₂O₃ retain volatile Pt and Rh, thereby recovering the volatile Pt and Rh that would otherwise be lost in the gas phase. Thereby, both emissions in the air and loss of precious and expensive metals are mitigated.

The present disclosure thus also provides for the use of one or more oxides of a rare earth metal oxide selected from the group consisting of Er₂O₃, Sm₂O₃ and/or Yb₂O₃, such as Er₂O₃ and/or Sm₂O₃, in crystalline form, for incorporating one or more volatile platinum group metals, in particular at least volatile Pt and/or Rh or at least volatile Rh, into the crystal lattice of the one or more oxides of a rare earth metal oxide selected from the group consisting of Er₂O₃, Sm₂O₃ and/or Yb₂O₃, such as Er₂O₃ and/or Sm₂O₃, in crystalline form. Hence, Er₂O₃, Sm₂O₃ and Yb₂O₃ have the ability to form a compound or a solid solution with Rh and Pt. Further, the formed compound or solid solution is stable: upon shut-down of the reactor and exposure to ambient temperature and ambient air, the compound or solid solution does not hydrate and do not become brittle and dusty.

In one embodiment according to the use of the disclosure, volatile Pt and/or Rh is generated during the catalytic oxidation of ammonia into nitric oxide, particularly using a Pt and Rh containing catalyst, or volatile Pt and/or Rh is generated from the catalytic reaction of ammonia with oxygen and methane into hydrogen cyanide. In particular, the present disclosure addresses the recovery of volatile Pt and Rh, even more in particular the recovery of volatile Rh. Two very well know industrial production processes are the production of nitric acid according to the Ostwald process and the production of hydrogen cyanide according to the Andrussow process, as described elsewhere herein.

It results that the use of Er₂O₃, Sm₂O₃ and/or Yb₂O₃, such as the use of Er₂O₃ and/or Sm₂O₃ for recovering volatile Pt and/or Rh, is particularly helpful for performing the Ostwald and Andrussow processes generating nitric acid and hydrogen cyanide, respectively.

In one embodiment according to the use of the disclosure, the oxide of the rare earth metal is Sm₂O₃. The inventor has found that the catchment of volatile Pt and Rh is even more increased when the rare earth oxide in the recovery system is Sm₂O₃. Said otherwise, there are benefits in terms of volatile Pt and Rh recovery associated with a recovery system comprising Sm₂O₃.

In one embodiment according to the use of the disclosure, volatile Rh is recovered.

In one embodiment according to the use of the disclosure, the oxide of the rare earth metal is Sm₂O₃ and volatile Rh is recovered.

In one embodiment according to the use of the disclosure, the oxide of a rare earth metal is comprised in a recovery system that has the shape of a honeycomb, a tablet, a pellet, a sponge, a net or a gauze, as described elsewhere herein.

In one aspect of the disclosure, a method for oxidising ammonia into nitric oxide or for reacting ammonia with oxygen and methane, thereby generating hydrogen cyanide, is disclosed. The method comprises the steps of a) catalytically oxidising ammonia into nitric oxide or catalytically reacting ammonia with oxygen and methane thereby generating hydrogen cyanide, whereby volatile Pt and/or Rh is generated, or stated differently whereby a gas phase is obtained comprising at least volatile Pt and/or Rh; and b) recovering the volatile Pt and/or Rh generated in step a) on a recovery system comprising one or more oxide of a rare earth metal selected from the group consisting of Er₂O₃, Sm₂O₃ and Yb₂O₃, particular in crystalline form, in particular by contacting the gas phase comprising at least volatile Pt and/or Rh, at suitable temperatures and pressures as known to the skilled person, with a recovery system comprising one or more oxide of a rare earth metal selected from the group consisting of Er₂O₃, Sm₂O₃ and Yb₂O₃.

Stated differently, the present disclosure provides a method for oxidising ammonia into nitric oxide or for reacting ammonia with oxygen and methane, thereby generating hydrogen cyanide, is disclosed. The method comprises the steps of
a) catalytically oxidising ammonia into nitric oxide or catalytically reacting ammonia with oxygen and methane thereby generating hydrogen cyanide, whereby volatile Pt and/or Rh is generated, or stated differently whereby a gas phase is obtained comprising at least volatile Pt and/or Rh, particularly a gas phase comprising at least volatile Rh;
b) contacting the volatile Pt and/or Rh generated in step a) with a recovery system comprising one or more oxide of a rare earth metal selected from the group consisting of Er₂O₃, Sm₂O₃ and Yb₂O₃, such as Er₂O₃ and/or Sm₂O₃, particular in crystalline form, in particular by contacting the gas phase comprising at least volatile Pt and/or Rh, at suitable temperatures and pressures as known to the skilled person, with a recovery system comprising one or more oxide of a rare earth metal selected from the group consisting of Er₂O₃, Sm₂O₃ and Yb₂O₃, such as Er₂O₃ and/or Sm₂O₃, to form a compound or a solid solution with Pt and/or Rh; and c) recovering Pt and/or Rh from the compound or solid solution generated in step b)

Under high temperature conditions in the ammonia oxidation burner, the Pt and/or Rh transform to gaseous PtO₂ and RhO₂. Due to the low stability of PtO₂ vapour, Pt may be captured with a recovery system comprising one or more oxide of a rare earth metal selected from the group consisting of Er₂O₃, Sm₂O₃ and Yb₂O₃, wherein it stays in an oxidised state, or it may easily lose oxygen and react with Pd in a metallic state to form a solid solution. The RhO₂ vapour is much more stable than PtO₂ and can be captured with a recovery system comprising one or more oxide of a rare earth metal selected from the group consisting of Er₂O₃, Sm₂O₃ and Yb₂O₃ to form a respective compound.

The inventor has surprisingly found that, contrary to cerium oxide, CeO2 and as shown in the examples, Er₂O₃, Sm₂O₃ and Yb₂O₃ retain volatile Pt and Rh, thereby recovering the volatile Pt and Rh that would otherwise be lost in the gas phase. Thereby, both the emissions in the air and the loss of precious and expensive metals are mitigated.

Hence, Er₂O₃, Sm₂O₃ and Yb₂O₃ have the ability to form a compound or a solid solution with Rh and Pt. Further, the formed compound or solid solution is stable: upon shut-down of the reactor and exposure to ambient temperature and ambient air, the compound or solid solution does not hydrate and do not become brittle and dusty.

In one embodiment according to the method of the disclosure, the recovery of Pt and/or Rh from the compound or solid solution generated in step c) is performed by any method as known to the skilled person. Some known methods include chelation, ion exchange, chemical precipitation, solvent extraction leaching, adsorption, and biosorption methods.

In one embodiment according to the method of the disclosure, step a) is performed with a catalytic gauze, and step b) is performed with a recovery system that has the shape of a honeycomb, a tablet, a pellet, a sponge, a net or a gauze, wherein these shapes are described elsewhere herein.

In one embodiment according to the method of the disclosure, step b) is performed with a recovery system comprising Sm₂O₃.

The inventor has found that the catchment of volatile Pt and Rh is even more increased when the rare earth metal oxide in the recovery step is Sm₂O₃. Said otherwise, there are benefits in terms of volatile Pt and Rh recovery associated with a recovery step comprising Sm₂O₃.

In one embodiment according to the method of the disclosure, step a) is performed with a Rh-containing catalytic system and step b) is performed with a recovery system comprising Sm₂O₃.

The inventor has found that not only does the recovery of volatile Pt and/or Rh improve upon using Sm₂O₃ in the recovery step, the Rh recovery is also then improved, that is more selective, with respect to Pt catchment. Said otherwise, the combination of a Rh catalyst and Sm₂O₃ in the recovery step of the method of the disclosure results in improved Rh recovery.

In certain embodiments, step b) of the methods of the present disclosure further comprises recovering volatile catalyst metal, such as volatile platinum group metals generated in step a) with a second recovery system. In a particular embodiment, the second recovery system comprises Pd for the capture of at least volatile Pt.

In one embodiment according to the method of the disclosure, step a) comprises catalytically oxidising ammonia into nitric oxide at a temperature ranging from 700 to 950° C., particularly at a pressure ranging between 2 bar and 20 bar.

By performing the conversion of ammonia into nitric oxide under such conditions, not only are the yield and the selectivity for nitric oxide improved, the emissions associated with the nitrous oxide side product are reduced. Further, nitric oxide can then be converted through further oxidation into the NOx gases NO₂ and N₂O₄ which when absorbed in water provide the very important chemical that is nitric acid.

In one aspect of the disclosure, a method for revamping a palladium-containing recovery gauze for recovering volatile platinum and/or rhodium is disclosed. The method comprises the step of replacing at least part of the palladium comprised in the recovery gauze for one or more oxide of a rare earth metal selected from the group consisting of Er₂O₃, Sm₂O₃ and Yb₂O₃, such as Er₂O₃ and/or Sm₂O₃.

### Examples

### Example 1: Use of Sm₂O₃ for Pt and Rh Catchment

Samarium oxide (Sm₂O₃) was pressed into a pellet of 10 mm diameter and 5 mm thickness. The tablets were sintered at 1100° C. for 12 hours. A pellet was installed downstream of seven Pt/Rh gauzes in an ammonia combustion reactor. The reactor was operated at 5 bara pressure and the combusted gas contacting the Sm₂O₃ tablet was at 900° C., containing circa 10% NO, 15% H₂O, 6% O₂ and nitrogen. In addition to these gases, the gas contained traces of volatile platinum and rhodium. The reactor was operated for 23 days. After this period of exposure, the pellet was recovered from the pilot reactor for analysis. Prior to installation in the reactor, the lower side of the pellet had been marked, so that after exposure the upper side of the pellet that had most direct contact with the incoming flow of combusted gas (upper surface) could be identified.

Analysis in a scanning electron microscope (SEM) with energy dispersive X-ray fluorescence analysis (EDS) was carried out. To obtain an average chemical composition of the near surface region of the upper side, EDS analysis of the tablet was carried out at low magnification. The normalised atomic ratios for Sm, Rh and Pt are shown in Table 1.

TABLE 1
EDS analysis of the upper surface of the Sm₂O₃ pellet

| Sm Atomic % | Rh Atomic % | Pt Atomic % |
|---|---|---|
| 93.3 | 4.3 | 2.4 |

These results show that both Rh and Pt were recovered, with more Rh being recovered.

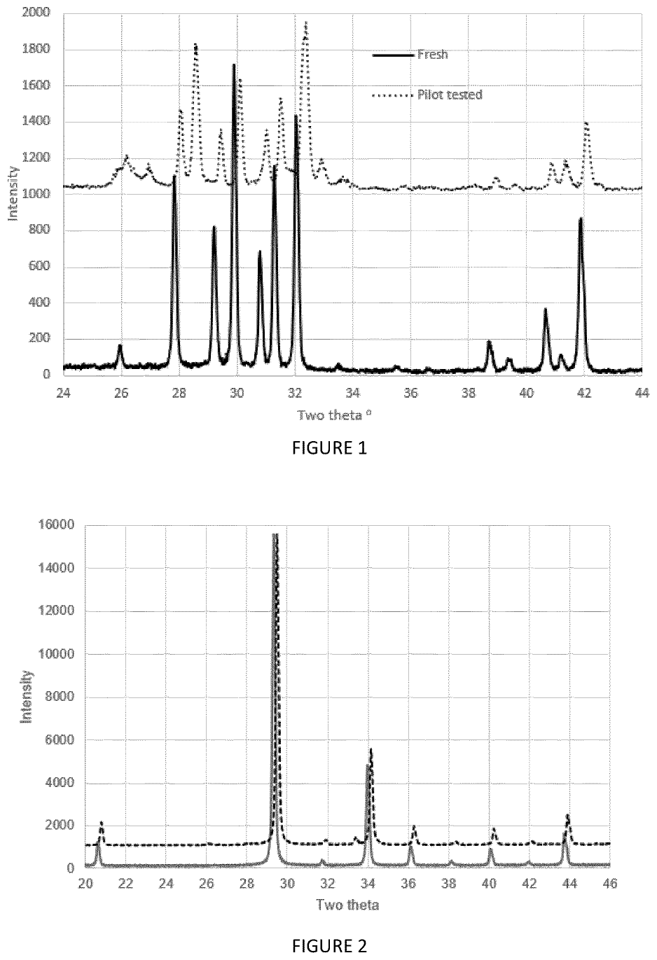

X-Ray diffraction (XRD) analysis of the upper side of the tablet was carried out to identify changes to the Sm₂O₃ structure. The diffraction patterns of the pellet before exposure to the reactor and of the upper side of the reactor exposed Sm₂O₃ pellet are shown in FIG. 1.

For the Sm₂O₃ tablet before exposure to the reactor (the “fresh” sample), we observed a monoclinic structure. It is known (Handbook on the Physics and Chemistry of Rare Earths, 1979, Vol 3, Ch 27. “The binary rare earth oxides”, LeRoy Eyring, p.341) that above 900° C., Sm₂O₃ adopts a monoclinic structure, whereas at lower temperatures, the equilibrium phase is body centred cubic. The monoclinic structure is consistent with the sample annealed at 1100° C., but on cooling below 900° C., the cooling rate was not sufficiently slow to allow the transition to the body centred cubic structure. After reactor exposure (the “pilot tested” sample), we observed both a monoclinic and a body centred cubic phase. This is consistent with operating the reactor at the body centred cubic—monoclinic transition temperature, followed by rapid cooling when the pilot reactor is shut down. We clearly observed that the lines of the remaining monoclinic phase had shifted to higher angles, indicating that the monoclinic Sm₂O₃ lattice has contracted.

### Example 2: Use of Er₂O₃ for Rh Catchment

An Erbium oxide (Er₂O₃) pellet was produced in the same manner as the corresponding Sm₂O₃ pellet produced in Example 1. After sintering and marking of the lower surface, the pellet was installed in the reactor in the same manner as the corresponding Sm₂O₃ pellet produced in Example 1. The exposure of the Er₂O₃ pellet in the reactor was carried out in parallel with the Sm₂O₃ pellet produced in Example 1. Average surface compositions of Er, Rh and Pt after exposition in the reactor was determined in the SEM equipped with an EDS analyser. The results are shown in Table 2. Only Rh was recovered on the Er₂O₃ pellet.

TABLE 2
EDS analysis of the upper surface of the Er₂O₃ pellet

| Er Atomic % | Rh Atomic % | Pt Atomic % |
|---|---|---|
| 97.2 | 2.8 | 0 |

X-Ray diffraction (XRD) analysis of the pellet before exposure and of the upper side of the reactor exposed pellet was carried out to identify changes to the Er₂O₃ structure. The diffraction patterns of the pellet before reactor exposure (solid line) and the upper side (dashed line) of the plant exposed Er₂O₃ pellet are shown in FIG. 2.

The pellet before exposure exhibited a body centered cubic structure, as reported before for Er₂O₃(Handbook on the Physics and Chemistry of Rare Earths, 1979, Vol 3, Ch 27. “The binary rare earth oxides”, LeRoy Eyring, p.341). After plant exposure, the Er₂O₃ pellet retained the body centered cubic structure, but the lattice had contracted as indicated by a shift in lines to a higher two theta angle.

### Example 3: Use of Yb₂O₃ for Rh Catchment

An Ytterbium oxide (Yb₂O₃) oxide pellet was prepared in the same manner as the corresponding Sm₂O₃ pellet produced in Example 1. After sintering and marking of the lower surface, the pellet was installed in the reactor in the same manner as the corresponding Sm₂O₃ pellet produced in Example 1. The exposure of the Yb₂O₃ pellet in the reactor was carried out in parallel with the Sm₂O₃ pellet produced in Example 1. Average surface compositions of Yb, Rh and Pt after exposition in the reactor was determined in the SEM equipped with an EDS analyser. The results are shown in Table 3.

TABLE 3
EDS analysis of the upper surface of the Yb₂O₃

| Yb Atomic % | Rh Atomic % | Pt Atomic % |
|---|---|---|
| 97.0 | 3.0 | 0 |

From table 3, we observed that Rh had been retained on the Yb₂O₃ pellet, contrary to Pt.

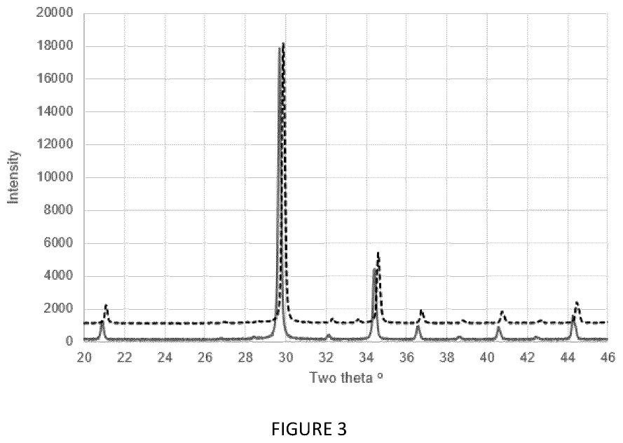

X-Ray diffraction (XRD) analysis of the upper side of the pellet was carried out to identify changes to the Yb₂O₃ structure. The diffraction patterns of the lower and upper sides of the reactor exposed Yb₂O₃ pellet are shown in FIG. 3.

As known (Handbook on the Physics and Chemistry of Rare Earths, 1979, Vol 3, Ch 27. “The binary rare earth oxides”, LeRoy Eyring, p.341), the Yb₂O₃ pellet before exposure to the reactor had a body centered cubic structure. After reactor exposure, the Yb₂O₃ pellet retained the body centered cubic structure but the lattice had contracted, as indicated by a shift in lines to a higher two theta angle.

### Example 4: No Catchment of Pt or Rh with CeO₂ (Comparative Example)

Under ambient conditions, cerium oxide is found in the form of cerium dioxide, CeO₂, with a fluorite structure. The lattice parameter is reported to be 5.4112 Å (Powder Diffraction File number 01-089-8436, Maintained by the International Centre for Diffraction Data (ICDD). Yara produces a catalyst for nitrous oxide abatement that is designed to be installed directly below the combustion gauzes in the ammonia burner of a nitric acid plant. The catalyst contains 97 mole % of CeO₂, with the remainder being an oxide active phase. The lattice parameter of the CeO₂ in a freshly produced catalyst gave a value of 5.4090 Å, which is within 0.04% of the reference material. After operation in a plant, no significant change to the CeO₂ lattice parameter was observed and no additional diffraction lines were observed in a corresponding XRD pattern. We concluded that CeO₂ does not retain Rh or Pt.

1. A catalytic system comprising:
a Pt-containing and/or Rh-containing catalyst, wherein volatile Pt and/or Rh are released from the catalyst during operation; and
a recovery system downstream of the catalyst for recovering the volatile Pt and/or Rh;
wherein the recovery system comprises one or more oxides of a rare earth metal selected from the group consisting of Er₂O₃, Sm₂O₃ and Yb₂O₃ and wherein the one or more oxides of a rare earth metal forms a compound or solid solution with the Pt and/or Rh.

2. The catalytic system according to claim 1, wherein the catalytic system is a system for the catalytic conversion of ammonia into nitric oxide, for the generation of nitric acid, or wherein the catalytic system is a system for the catalytic conversion of ammonia, oxygen and methane, for the generation of hydrogen cyanide.

3. The catalytic system according to claim 1, wherein the recovery system comprises Sm₂O₃.

4. The catalytic system according to claim 3, wherein the catalytic system comprises a Rh-containing catalyst.

5. The catalytic system according to claim 1, wherein the Pt-containing and/or Rh-containing catalyst is in a form of a catalytic gauze, and wherein the recovery system has a shape of a honeycomb, a tablet, a pellet, a sponge, a net, or a gauze.

6. (canceled)

7. (canceled)

8. (canceled)

9. (canceled)

10. (canceled)

11. A method for oxidising ammonia into nitric oxide or for reacting ammonia with oxygen and methane, thereby generating hydrogen cyanide, the method comprising steps of:
a) catalytically oxidising ammonia into nitric oxide or catalytically reacting ammonia with oxygen and methane thereby generating hydrogen cyanide, whereby volatile Pt and/or Rh is generated;
b) contacting the volatile Pt and/or Rh generated in step a) with a recovery system comprising one or more oxides of a rare earth metal selected from the group consisting of Er₂O₃, Sm₂O₃, and Yb₂O₃ to form a compound or a solid solution with the Pt and/or Rh; and
c) recovering the Pt and/or Rh from the compound or the solid solution generated in step b).

12. The method according to claim 11, wherein step a) is performed with a catalytic gauze, and wherein step b) is performed with a recovery system that has the shape of a honeycomb, a tablet, a pellet, a sponge, a net, or a gauze.

13. The method according to claim 11, wherein in step b) the oxide of the rare earth metal is Sm₂O₃.

14. The method according to claim 13, wherein step a) is performed with a Rh-containing catalytic system.

15. The method according to claim 11, wherein step a) comprises catalytically oxidising ammonia into nitric oxide in the production of nitric acid at a temperature ranging from 700° C. to 950° C.

16. A method for revamping a recovery gauze for recovering volatile Pt and/or Rh, wherein the recovery gauze comprises palladium, the method comprising a step of replacing at least part of the palladium in the recovery gauze with one or more oxides of a rare earth metal selected from the group consisting of Er₂O₃, Sm₂O₃ and Yb₂O₃, wherein the one or more oxides of the rare earth metal forms a compound or solid solution with the Pt and/or Rh.
